(19) United States
(12) Patent Application Publication
(10) Pub. No.: US 2026/0051819 A1
(43) Pub. Date: Feb. 19, 2026

(54) SEMICONDUCTOR SYSTEM WITH VOLTAGE REGULATOR AND METHOD FOR OPERATING THE SAME

(71) Applicant: TAIWAN SEMICONDUCTOR MANUFACTURING COMPANY LTD., HSINCHU (TW)

(72) Inventors: SZU-CHUN TSAO, HSINCHU CITY (TW); YI-HSIANG WANG, NEW TAIPEI CITY (TW)

(21) Appl. No.: 18/805,575

(22) Filed: Aug. 15, 2024

(51) Int. Cl. H02M 3/158

(52) U.S. Cl. CPC H02M 3/158

(57) ABSTRACT

A semiconductor system and an operating method are provided. The semiconductor system includes a voltage regulator, a first capacitor, and a second capacitor. The voltage regulator is configured to modulate a sinking current and a sourcing current associated with a plurality of loading circuits. Each of the plurality of loading circuits may include a high-voltage portion and a low-voltage portion. The first capacitor is electrically connected to the voltage regulator to stabilize the sinking current from each of the high-voltage portion of the plurality of loading circuits. The first capacitor is external to the plurality of loading circuits. The second capacitor, electrically connected to the voltage regulator to stabilize the sourcing current transmitted to each of the low-voltage portion of the plurality of loading circuits. The second capacitor is external to the plurality of loading circuits.

### BACKGROUND

The present disclosure relates, in general, to semiconductor systems and methods for operating the same. Specifically, the present disclosure relates to semiconductor systems and methods for operating semiconductor systems with a voltage regulator.

Voltage regulators have been widely used in various applications such as providing voltage reference or modulating output voltage for loading circuits. Large capacitors are sometimes utilized to facilitate stable operations of the voltage regulators, which can increase routing costs and impact reliability. Furthermore, when the number of loading circuits increases, it takes time to correspondingly adjust or design the voltage regulator.

### BRIEF DESCRIPTION OF THE DRAWINGS

Aspects of the embodiments of the present disclosure are best understood from the following detailed description when read with the accompanying figures. It should be noted that, in accordance with standard practice in the industry, various structures are not drawn to scale. In fact, the dimensions of the various structures can be arbitrarily increased or reduced for clarity of discussion.

FIG. 1A is a schematic view of a semiconductor system with a voltage regulator, in accordance with some embodiments of the present disclosure.

FIG. 1B is a schematic view of a semiconductor system with a voltage regulator for modulating a sinking current, in accordance with some embodiments of the present disclosure.

FIG. 1C is a schematic view of a semiconductor system with a voltage regulator for modulating a sourcing current, in accordance with some embodiments of the present disclosure.

FIG. 2A is a schematic view of a semiconductor system with a voltage regulator in association with multiple loading circuits, in accordance with some embodiments of the present disclosure.

FIG. 2B is another schematic view of a semiconductor system with two voltage regulators in association with multiple loading circuits, in accordance with some embodiments of the present disclosure.

FIG. 3A is a cross-section of a semiconductor system with a voltage regulator and loading circuits, in accordance with some embodiments of the present disclosure.

FIG. 3B is a cross-section of loading circuits of the semiconductor system of FIG. 3A showing multiple metal layers, in accordance with some embodiments of the present disclosure.

FIG. 4A is a schematic view of a voltage regulator with capacitors, in accordance with some embodiments of the present disclosure.

FIG. 4B is a schematic view of a biasing circuit of the voltage regulator, in accordance with some embodiments of the present disclosure.

FIG. 4C is a schematic view of a voltage regulator with capacitors for modulating a sinking current, in accordance with some embodiments of the present disclosure.

FIG. 4D is a schematic view of a voltage regulator with capacitors for modulating a sourcing current, in accordance with some embodiments of the present disclosure.

FIG. 5 is a schematic view of a voltage regulator with multiple amplifiers, in accordance with some embodiments of the present disclosure.

FIG. 6 is a top view of a semiconductor system with a voltage regulator and capacitors, in accordance with some embodiments of the present disclosure.

### DETAILED DESCRIPTION

The following disclosure provides many different embodiments, or examples, for implementing different features of the provided subject matter. Specific examples of elements and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features can be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “over,” “upper,” “on” and the like, can be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus can be otherwise oriented (rotated 90 degrees or at other orientations) and the spatially relative descriptors used herein may likewise be interpreted accordingly.

As used herein, although terms such as “first,” “second” and “third” describe various elements, components, regions, layers and/or sections, these elements, components, regions, layers and/or sections should not be limited by these terms. These terms may only be used to distinguish one element, component, region, layer or section from another. Terms such as “first,” “second” and “third” when used herein do not imply a sequence or order unless clearly indicated by the context.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the respective testing measurements. Also, as used herein, the terms “substantially,” “approximately” and “about” generally mean within a value or range that can be contemplated by people having ordinary skill in the art. Alternatively, the terms “substantially,” “approximately” and “about” mean within an acceptable standard error of the mean when considered by one of ordinary skill in the art. People having ordinary skill in the art can understand that the acceptable standard error may vary according to different technologies. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the terms “substantially,” “approximately” or “about.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as from one endpoint to another endpoint or between two endpoints. All ranges disclosed herein are inclusive of the endpoints, unless specified otherwise.

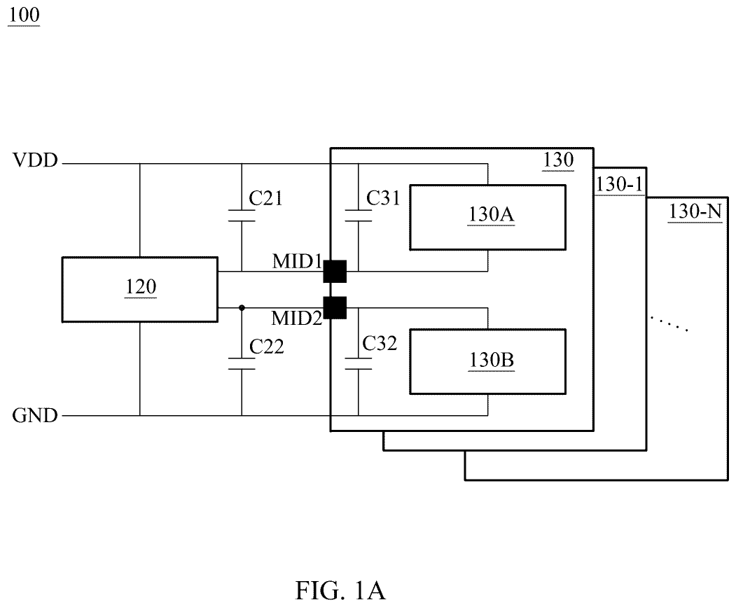

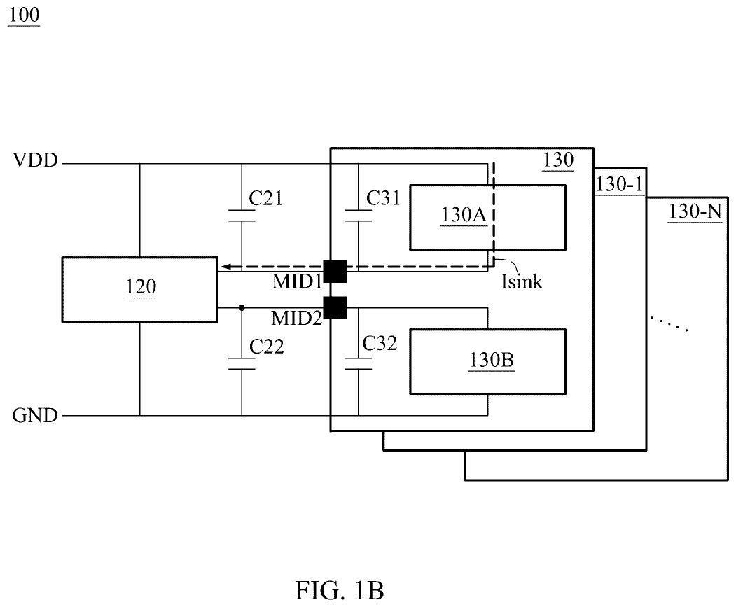

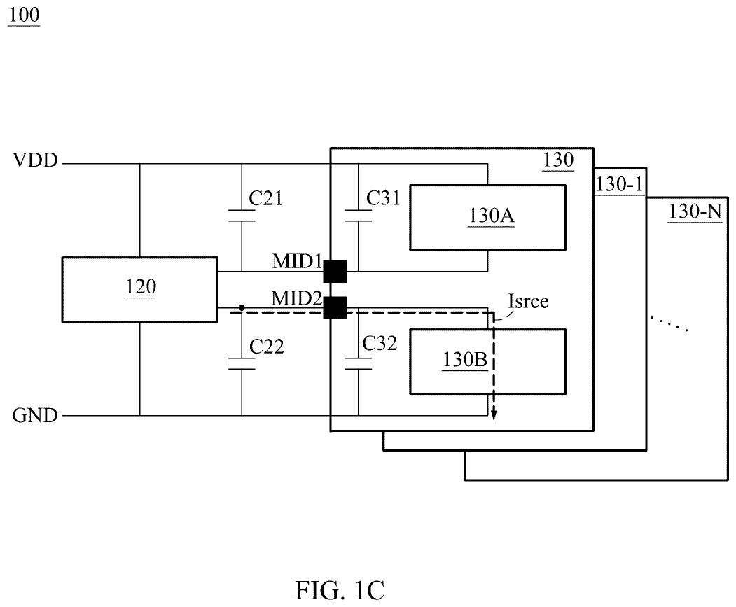

FIG. 1A is a schematic view of a semiconductor system 100 with a voltage regulator 120, in accordance with some embodiments of the present disclosure. The semiconductor system 100 includes a voltage regulator 120, capacitors C21 and C22, and several loading circuits 130, 130-1 to 130-N. Each of the loading circuits 130, 130-1 to 130-N can include a high-voltage portion 130A, a low-voltage portion 130B, and capacitors C31 and C32. The semiconductor system 100 includes a voltage regulator 120, capacitors C21, C22, C31, C32, a high-voltage portion 130A and a low-voltage portion 130B. The capacitors C21 and C22 are adjacent to the voltage regulator 120 and external to the loading circuits 130 to 130-N. The capacitors C21 and C22 are excluded by the loading circuits 130 to 130-N. The capacitors C31 and C32 are included by or embedded within the loading circuits 130 to 130-N.

In some embodiments, each of the loading circuits 130 to 130-N includes the capacitors C31 and C32 to mitigate or decrease the noisy transient signals during the operation of the loading circuits 130 to 130-N. Accordingly, since each of the loading circuits 130 to 130-N has its corresponding the capacitors C31 and C32, the area of the capacitors C21 and C22 for the voltage regulator 120 can be decreased. This advantage will be more obvious as the number of the loading circuits 130 to 130-N increases.

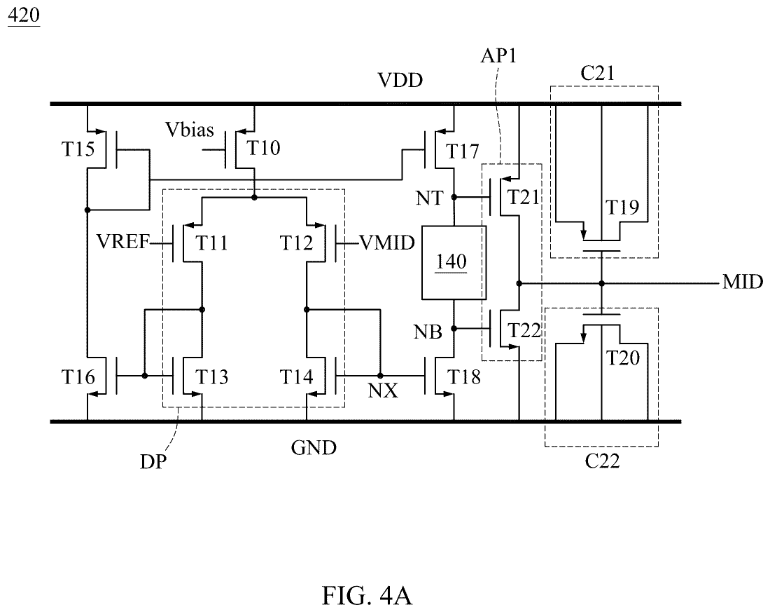

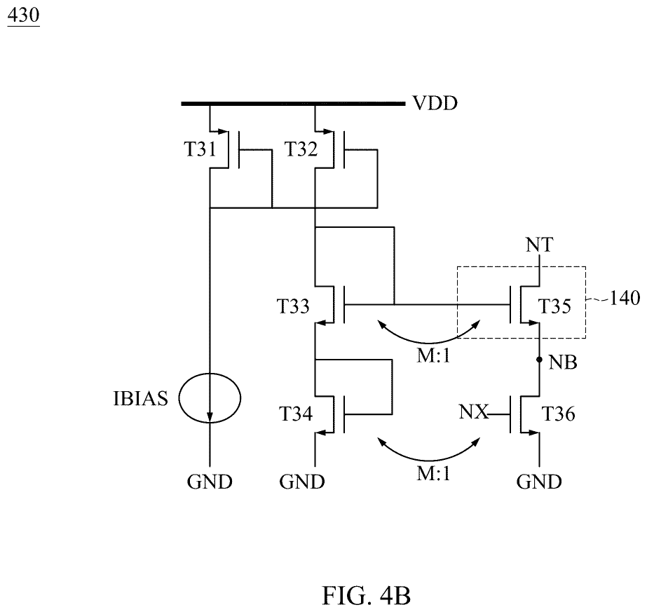

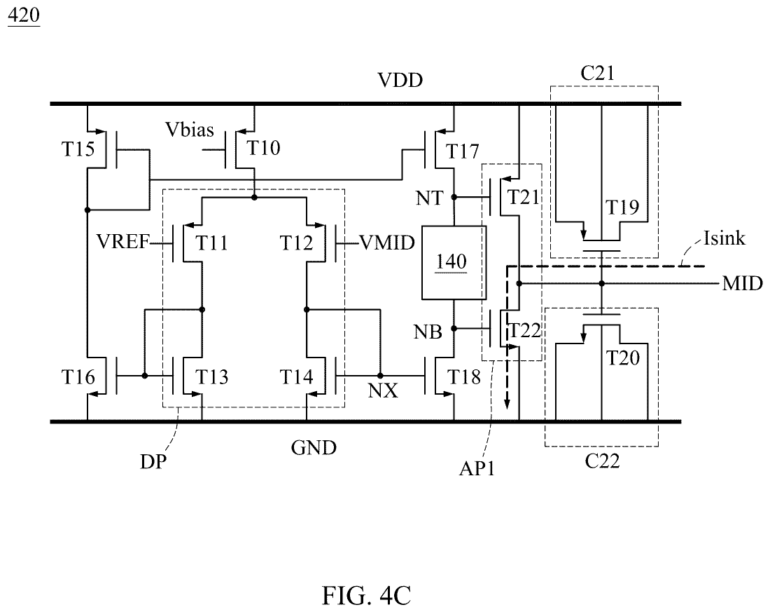

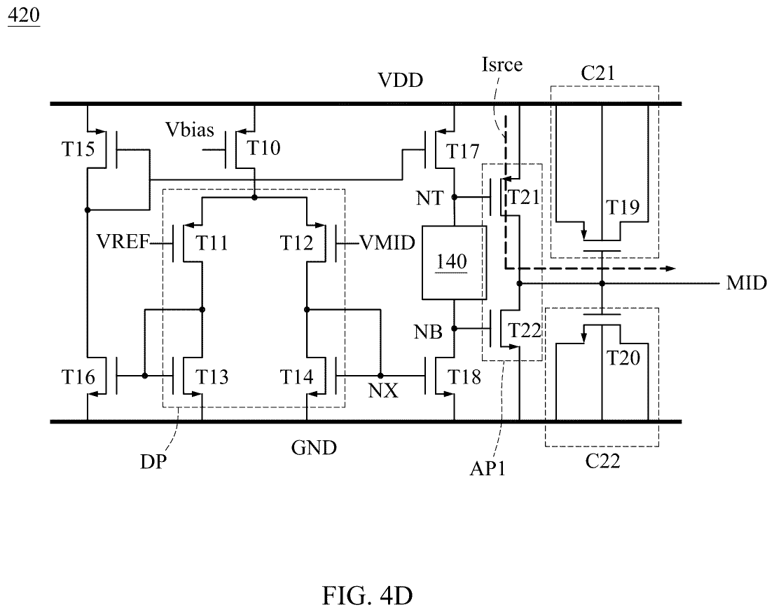

The voltage regulator 120 can include a low-dropout regulator (LDO) that can regulate voltages for the loading circuits 130 to 130-N. The voltage regulator 120 can include a middle-range LDO with sinking and sourcing capability for the loading circuits 130 to 130-N. The voltage regulator 120 is electrically connected to the port VDD for power supply, the ports MID1 and MID2 for regulating voltages, and the port GND for ground. In some embodiments, the ports MID1 and MID2 can be merged or integrated into one single port. The voltage regulator 120 can include at least one amplifier and a biasing circuit, which will be described with more details in the embodiment of FIG. 4.

The voltage regulator 120 can be used to provide a voltage reference for the loading circuits 130 to 130-N of core/core device only design to work in a safe operating area (SOA). The output of the voltage regulator 120 can track IO power and/or core power dynamically. The term “core” or “core device” can refer to the central processing unit (CPU) of the semiconductor system 10, also referred to as a central processor, main processor or simply processor. The core can be the electronic circuitry that executes instructions comprising a computer program, and performs basic arithmetic, logic, controlling, and input/output (I/O) operations specified by the instructions in the program. The core can be circuitry separate from the components that comprise the main memory and IO circuitry. The IO circuitry can be any component that communicates between components internal to or external to the semiconductor system 10. In some embodiments, core devices are configured to operate at a lower voltage and higher frequency than those of the IO circuitry. Each of the loading circuits 130 to 130-N includes a high-voltage portion 130A and a low-voltage portion 103B operated in two different voltage ranges. The voltage range of the high-voltage portion 130A is higher than the voltage range of the low-voltage portion 130B. For example, the high-voltage portion 130A can operate in the range of around 0.4V to around 1.1V, and the low-voltage portion 130B can operate in the range of 0V to around 0.7V.

The high-voltage portion 130A is electrically connected between the port VDD and the port MID1. The voltage at the port VDD is higher than the voltage at the port MID1. The low-voltage portion 130B is electrically connected between the port MID2 and the port GND. The voltage at the port MID2 is higher than the voltage at the port GND. The voltage at the port MID1 can be different from the voltage at the port MID2. The voltage at the port MID1 can be substantially identical to the voltage at the port MID2. The voltage at the port MID1 can exceed the voltage at the port MID2, or be lower.

The capacitor C31 is electrically connected between the port VDD and the port MID1. The capacitor C31 is disposed near the high-voltage portion 130A to decrease noise or interference from the high-voltage portion 130A. The capacitor C31 can be used to debounce the noisy transient signals of loading circuit 130. The capacitor C31 can be used to filter high frequency signals of the semiconductor system 100 during loading transitions with the loading circuit 130.

The capacitor C32 is electrically connected between the port MID2 and the port GND. The capacitor C32 is disposed near the low-voltage portion 130B to decrease noise or interference from the high-voltage portion 130B. The capacitor C32 can be used to debounce the noisy transient signals of loading circuit 130. The capacitor C32 can be used to filter high frequency signals of the semiconductor system 100 during loading transitions with the loading circuit 130.

The capacitor C21 is electrically connected between the port VDD and the voltage regulator 120. The capacitor C21 is disposed adjacent to the voltage regulator 120 for compensating and preventing high variation therein. The capacitor C21 can stabilize the sinking current from the high-voltage portion 130A of the loading circuit 130 to the voltage regulator 120. The area of the capacitor C21 can be reduced as capacitor C31 is provided correspondingly within the loading circuit 130.

The capacitor C22 is electrically connected between the port GND and the voltage regulator 120. The capacitor C22 is disposed adjacent to the voltage regulator 120 for compensating and preventing high variation therein. The capacitor C22 can stabilize the sourcing current from the voltage regulator 120 to the low-voltage portion 130B of the loading circuit 130. The area of the capacitor C22 can be reduced as the capacitor C32 is provided correspondingly within the loading circuit 130.

FIG. 1B is a schematic view of a semiconductor system 100 with a voltage regulator 120 for modulating a sinking current Isink, in accordance with some embodiments of the present disclosure. The voltage regulator 120 is used to modulate or adjust the sinking current Isink from the high-voltage portion 130A. When the high-voltage portion 130A is operated, the sinking current Isink passes from the high-voltage portion 130A through the port MID1 to the voltage regulator 120. The capacitor C31 allows sinking or pulling the sinking current Isink that may be required by the voltage regulator 120, and such sinking capacity can be used to filter high frequency signals during loading transitions between the voltage regulator 120 and the high-voltage portion 130A. Accordingly, the voltage regulator 120 associated with the capacitor C31 can stabilize the loading circuit 130 by keeping the high-voltage portion 130A variation low.

FIG. 1C is a schematic view of a semiconductor system 100 with a voltage regulator 120 for modulating a sourcing current Isrce, in accordance with some embodiments of the present disclosure. The voltage regulator 120 is used to modulate or adjust the sourcing current Isrce to the low-voltage portion 130B. When the low-voltage portion 130B is operated, the sourcing current Isrce passes from the voltage regulator 120 through the port MID2 to the low-voltage portion 130B. The capacitor C32 allows sourcing or pushing the sourcing current Isrce that may be required by the voltage regulator 120, and such sourcing capacity can be used to filter high frequency signals during loading transitions between the voltage regulator 120 and the low-voltage portion 130B. Accordingly, the voltage regulator 120 associated with the capacitor C32 can stabilize the loading circuit 130 by keeping the low-voltage portion 130B variation low.

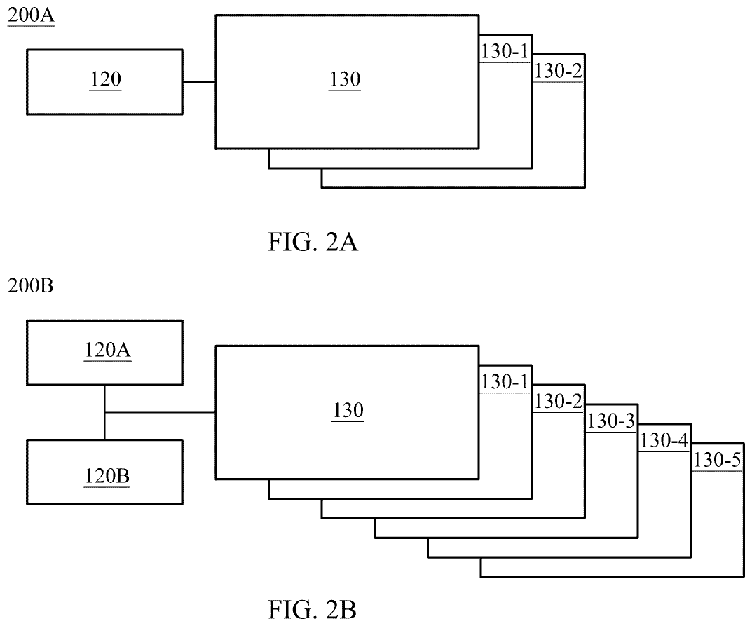

FIG. 2A is a schematic view of a semiconductor system 200A with a voltage regulator 120 in association with multiple loading circuits 130, 130-1 and 130-2, in accordance with some embodiments of the present disclosure. The semiconductor system 200A of FIG. 2A is similar to the semiconductor system 100 of FIG. 1A, and thus some elements are omitted for simplicity and clarity.

In some embodiments, the voltage regulator 120 can be a modularized device. As shown in FIG. 2A, the voltage regulator 120 is applicable for loading circuits 130, 130-1 and 130-2. The voltage regulator 120 can drive or modulate loading circuits 130, 130-1 and 130-2. The loading circuits 130, 130-1 and 130-2 can be identical or similar. In some embodiments, each of the loading circuits 130, 130-1 and 130-2 includes the capacitors C31 and C32 to mitigate the noisy transient signals and enhance the reliability. In some embodiments, the capacitors C21 and C22 can be provided between the voltage regulator 230 and the loading circuits 130, 130-1 and 130-2.

FIG. 2B is another schematic view of a semiconductor system 200B with two voltage regulators 120A and 120B in association with multiple loading circuits 130 to 130-5, in accordance with some embodiments of the present disclosure.

Voltage regulators 120A and 120B of FIG. 2B are identical to the voltage regulator 120 of FIG. 2A. As shown in FIG. 2B, the six loading circuits, 130 to 130-5, cannot be regulated or adjusted by a single voltage regulator having maximum capacity such as three. Therefore, two modularized voltage regulators 120A and 120B are provided correspondingly. By modularizing the voltage regulators, the cycle time to design or adjust the semiconductor system 200B can be reduced. In alternative embodiments, if there are N voltage regulators, each capable of regulating up to M loading circuits, the semiconductor system will be capable of regulating a total of MxN loading circuits.

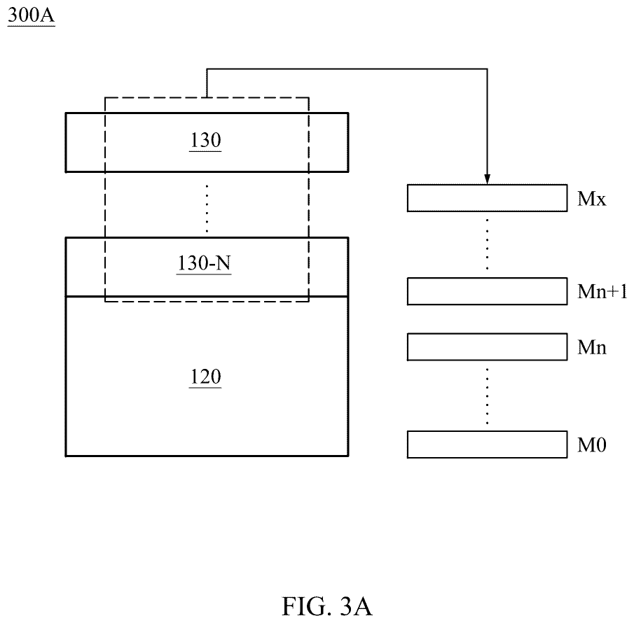

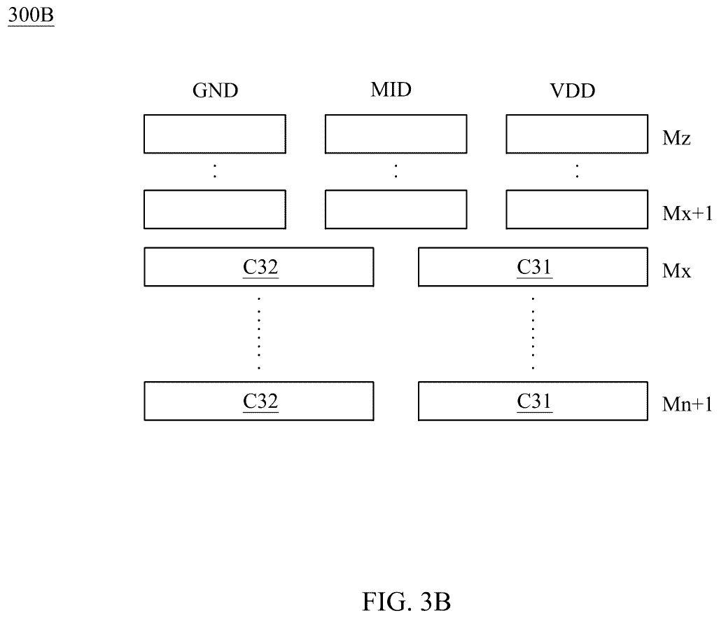

FIG. 3A is a cross-section of a semiconductor system 300A with a voltage regulator 120 and loading circuits 130 to 130-N, in accordance with some embodiments of the present disclosure. The semiconductor system 300A of FIG. 3A is similar to the semiconductor system 100 of FIG. 1A, and thus some elements are omitted here for simplicity and clarity.

As shown in FIG. 3A, the loading circuits 130 to 130-N are formed above the voltage regulator 120 from a cross-sectional perspective. In some embodiments, FIG. 3A depicts a schematic cross-section of a semiconductor wafer. The voltage regulator 120 is disposed on a substrate (not shown) of a semiconductor wafer, and the loading circuits 130 to 130-N are disposed on the voltage regulator 120. Accordingly, from the top view, the voltage regulator 120 substantially overlaps the loading circuits 130 to 130-N, reducing the area or footprint of semiconductor system 300. In some embodiments, the loading circuits 130 to 130-N include a plurality of metal layers MO to Mx, wherein metal layer MO is the bottommost and Mx the top. The metal layers MO to Mx are arranged adjacent to the loading circuits 130 to 130-N and the voltage regulator 120 from a cross-sectional perspective. The plurality of metal layers are disposed in proximity to the mentioned circuits and regulator. Isolation materials/layers disposed between each of plurality of metal layers MO to Mx are omitted for simplicity and clarity.

In some embodiments, the metal layers MO to Mx can further be divided into two portions including metal layers MO to Mn and metal layers Mn+1 to Mx. As shown in FIG. 3A, the metal layers Mn+1 to Mx are formed above metal layers MO to Mn in cross section. MO to Mn are configured for routing signals of the loading circuits 130 to 130-N, and Mn+1 to Mx to form the two capacitors C31 and C32 of the loading circuits 130 to 130-N. Based on the foregoing, the embedded capacitors and signal routing can be provided for the loading circuits 130 to 130-N without increasing area or space of the semiconductor system 300.

FIG. 3B is a cross-section of the semiconductor system 300B with multiple metal layers Mx+1 to Mz, in accordance with some embodiments of the present disclosure. FIG. 3B could serve as an extension to the structure depicted in FIG. 3A. Isolation materials/layers disposed between each of plurality of metal layers Mn+1 to Mz are omitted for simplicity and clarity. Compared to the semiconductor system 300A in FIG. 3A, additional metal layers Mx+1 to Mz are formed above the metal layers Mn+1 to Mx. As shown in FIG. 3B, the metal layers Mx+1 to Mz can be used to form the ports GND, MID and VDD. The ports GND, MID and VDD can be provided above the metal layers Mn+1 to Mx, which correspond to the capacitors C31 and C32. The ports GND, MID and VDD can be formed at the same escalation level. The port MID is formed between the port GND and the port VDD.

FIG. 4A is a schematic view of a voltage regulator 420 with capacitors C21 and C22, in accordance with some embodiments of the present disclosure. The voltage regulator 420 of FIG. 4A is similar to the voltage regulator 120 of FIG. 1A, with details as follows.

In some embodiments, the voltage regulator 420 includes a biasing circuit 140, and a plurality of transistors T11, T12, T13, T14, T15, T16, T17, R18, T21, and T22 between the VDD port and the GND port. The transistors T11, T12, T13, T14, T15, T16, T17, R18, T21, and T22 can be configured to provide various functions. For example, the transistors T21 and T22 can be formed or function as an amplifier AP1. The transistors T21 and T22 of the amplifier AP1 can be a folded-cascode class-AB based amplifier. The transistors T21 and T22 of the amplifier AP1 can be a low energy-consuming and well-biased Class AB based amplifier. The transistors T11 to T14 can be formed or function as a differential pair circuit. In some embodiments, the voltage regulator 420 can at least include a biasing circuit 140, an amplifier AP1, and a differential pair circuit DP, to provide sinking and sourcing capability associated with the loading circuits.

In some embodiments, the voltage regulator 420 is configured to regulate or modulate the output voltage VMID for a plurality of loading circuits. The transistors T21 and T22 are configured to provide a sinking current and a sourcing current to the loading circuits. The biasing circuit 140 is configured to dynamically control the transistors T21 and T22 in response to a comparison between the output voltage VMID and the reference voltage VREF. In addition, the transistor T19 can be formed or function as a capacitor C21 to improve the stability and decrease the variation of the voltage regulator 420. The transistor T20 can be formed or function as a capacitor C22 to improve the stability and decrease the variation of the voltage regulator 420. The transistors T19 and T20 are formed between the VDD port and the GND port. The transistor T19 is electrically connected to the voltage regulator 420 to stabilize the sinking current from the loading circuits. The transistor T20 is electrically connected to the voltage regulator 420 to stabilize the sourcing current to the loading circuits.

As shown in FIG. 4A, the transistor T21 can be a PMOS transistor, and the transistor T22 a NMOS transistor. The biasing circuit 140 is electrically connected to a gate of the transistor T21 through the node NT. The biasing circuit 140 is electrically connected to a gate of the transistor T22 through the node NB. In addition, the reference voltage VREF can be from an external power supply source or auto-tracking the supply voltages at the port VDD. The output voltage VMID is the voltage at the port MID1 or MID2 as shown in FIG. 1A. In some embodiments, the ports MID1 and MID2 can be merged or integrated into one single port. In some embodiments, a feedback mechanism or method is provided by the voltage regulator 420 such that the output voltage VMID can approximate or approach the reference voltage VREF.

Regarding the differential pair circuit DP, the transistor T11 includes a PMOS transistor, the transistor T12 includes a PMOS transistor, the transistor T13 includes a NMOS transistor, and the transistor T14 includes a NMOS transistor. The gate of transistor T1l is used to receive the reference voltage VREF. The drain of the transistor T11 is electrically connected to the drain of transistor T13. The source of the transistor T13 is electrically connected to the port GND. The gate of the transistor T13 is electrically connected to the drains of the transistors T11 and T13. The gate of transistor T12 is used to receive the output voltage VMID. The drain of the transistor T12 is electrically connected to the drain of transistor T14. The source of the transistor T14 is electrically connected to the port GND. The gate of the transistor T14 is electrically connected to the drains of the transistors T12 and T14. The Source/drain region(s) may refer to a source or a drain, individually or collectively dependent upon the context.

In some embodiments, the gate of the transistor T14 is electrically connected to the gate of transistor T18 through the node NX. The drain of the transistor T18 is electrically connected to the biasing circuit 140 and the gate of the transistor T22. Furthermore, the drain of the transistor T17 is electrically connected to the biasing circuit 140 and the gate of the transistor T21. The source of the transistor T17 is electrically connected to the port VDD. The gate of the transistor T17 is electrically connected to the gate and drain of the transistor T15. The drain of the transistor T15 is electrically connected to the drain of the transistor T16. The gate of the transistor T16 is electrically connected to the gate and the drain of the transistor T13. Both the sources of the transistors T15 and T10 are electrically connected to the port VDD. The gate of the transistor T10 is used to receive the bias voltage Vbias. The drain of the transistor T10 is electrically connected to the sources of the transistors T11 and T12. The bias voltage Vbias can be from an external power supply source or auto-tracking the supply voltages at the port VDD.

FIG. 4B is a schematic view of a biasing circuit 140 of a circuit 430 corresponding to the voltage regulator 420, in accordance with some embodiments of the present disclosure. The circuit 430 includes a current source IBIAS, and several transistors T31, T32, T33, T34, T35, and T36. The circuit 430 of FIG. 4B can be included in the voltage regulator 420 of FIG. 4A.

The sources of the transistors T31 and T32 are electrically connected to the port VDD. The drain and gate of each of the transistors T31, T32, T33, and T34 is electrically connected to each other to be operated as a diode. The gate of the transistor T33 is electrically connected to the gate of the transistor T35. The gate of the transistor T34 is electrically connected to the gate of the transistor T36. The current source IBIAS is electrically connected between the port GND and the drain of the transistor T31. The current source IBIAS can be from an external power supply source or auto-tracking the supply voltages at the port VDD.

In addition, the drain of the transistor T35 is electrically connected to the node NT. The source of the transistor T35 is electrically connected to the drain of the transistor T36 through the node NB. The gate of the transistor T36 is electrically connected to the node NX. The ratio of the sizes or aspect ratio between the transistors T33 and T35 is M to 1. The ratio of the current between the transistors T33 and T35 is M to 1. The ratio of the sizes or aspect ratio between the transistors T34 and T36 is M to 1. The ratio of the current between the transistors T34 and T36 is M to 1. The transistor T35 of FIG. 4B can correspond to the biasing circuit 140 of FIG. 4A. The transistor T36 of FIG. 4B can correspond to the transistor T18 of FIG. 4A.

FIG. 4C is a schematic view of a voltage regulator 420 with capacitors C21 and C22 for modulating a sinking current Isink, in accordance with some embodiments of the resent disclosure.

In some embodiments, when the output voltage VMID is greater than the reference voltage VREF, the sinking current Isink will be provided or modulated in association with the loading circuits. When the loading circuits are operated in a high-voltage range, such as 0.4V to 1.1V, the sinking current Isink can pass from the loading circuits to the transistor T22 of the voltage regulator 420.

During the sinking operation, the output voltage VMID is greater than the reference voltage VREF, and the voltage at the node NX decreases accordingly. Afterwards, the voltage at the node NB increases, such that the output voltage VMID decreases and approximates the reference voltage VREF. The transistor T22 is used to sink or pull the sinking current Isink from the loading circuits as the voltage at the node NB increases.

In some embodiments, when the output voltage VMID exceeds the reference voltage VREF, the voltage at the gate of the transistor T13 increases and the voltage at the gate of the transistor T15 decreases. Consequently, the voltage at the node NT increases, and the voltage at the node NB increases to allow the sinking current Isink passing through the transistor T22. In addition, the output voltage VMID decreases and approximates the reference voltage VREF. Both the voltages at the nodes NT and NB are increased during the sinking operation.

FIG. 4D is a schematic view of a voltage regulator 420 with capacitors C21 and C22 for modulating a sourcing current Isrce, in accordance with some embodiments of the present disclosure.

In some embodiments, when the output voltage VMID is lower than the reference voltage VREF, the sourcing current Isrce will be provided or modulated in association with the loading circuits. When the loading circuits operate in a low-voltage range, such as 0V to 0.7V, the sourcing current Isrce can pass from the transistor T21 of the voltage regulator 420 to the loading circuits. In some embodiments, the low-voltage range can be partially overlaping the high-voltage range.

During the sourcing operation, the output voltage VMID is lower than the reference voltage VREF, and the voltage at the node NX increases accordingly. Afterwards, the voltage at the node NB decreases, such that the output voltage VMID increases and approximates the reference voltage VREF. The transistor T21 is used to provide or push the sourcing current Isrce to the loading circuits as the voltage at the node NB decreases.

In some embodiments, when the reference voltage VREF exceeds the output voltage VMID, the voltage at the gate of the transistor T13 decreases, and the voltage at the gate of the transistor T15 increases. Consequently, the voltage at the node NT decreases to allow the sourcing current Isrce passing through the transistor T21. In addition, the output voltage VMID increases and approximates the reference voltage VREF. Both the voltages at the nodes NT and NB decrease during the sourcing operation.

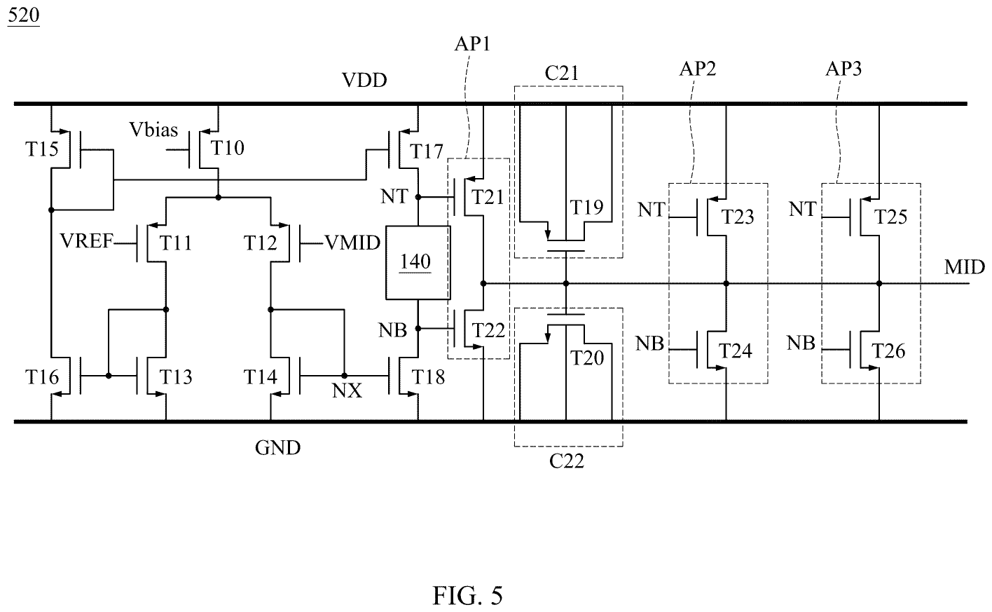

FIG. 5 is a schematic view of a voltage regulator 520 with multiple amplifiers AP1, AP2 and AP3, in accordance with some embodiments of the present disclosure. The voltage regulator 520 of FIG. 5 is similar to the voltage regulator 420 of FIG. 4A, with differences therebetween as follows.

Compared to the voltage regulator 420 of FIG. 4A, the voltage regulator 520 of FIG. 5 includes three amplifiers AP1, AP2, and AP3. The amplifier AP1 includes two transistors T21 and T22. The amplifier AP2 includes two transistors T23 and T24. The amplifier AP3 includes two transistors T25 and T26. Each of the amplifiers AP1, AP2, and AP3 can be a folded-cascode class-AB based amplifier. Each of the amplifiers AP1, AP2, and AP3 can be a low energy-consumed and well-biased Class AB based amplifier.

In some embodiments, the number of amplifiers of the voltage regulator 520 is proportional to the number of the loading circuits. The number of the amplifiers of the voltage regulator 520 can be increased with the number of loading circuits, where the number of the loading circuits does not exceed the loading capacity of the voltage regulator 520. When the number of the loading circuits does exceed the loading capacity of the voltage regulator 520, multiple voltage regulators 520 will be required as shown in the embodiments of FIG. 2B.

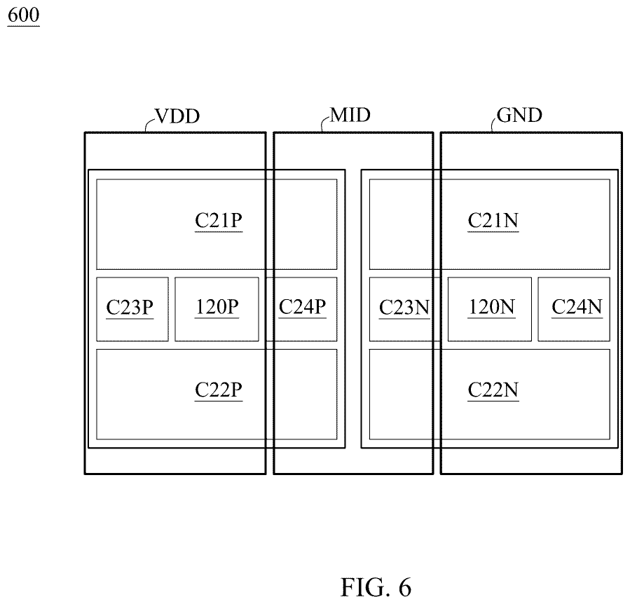

FIG. 6 is a top view of a semiconductor system 600 with voltage regulators and capacitors, in accordance with some embodiments of the present disclosure. FIG. 6 shows a schematic layout of a semiconductor system 600 from a top view perspective. The semiconductor system 600 includes the voltage regulators 120P and 120N, and capacitors C21P, C22P, C23P, C24P, C21N, C22N, C23N, C24N, and three voltage domains at the ports VDD, MID, and GND.

In some embodiments, the voltage regulators 120N and 120P of FIG. 6 can correspond to or belong to the voltage regulator 120 of FIG. 1A. The capacitors C21P, C22P, C23P, C24P, C21N, C22N, C23N, C24N of FIG. 6 can correspond to or belong to the capacitors C21 and C22 of FIG. 1A. The port MID of FIG. 6 can correspond to or belong to the ports MID1 and MID2 of FIG. 1A.

As shown in FIG. 6, in some embodiments, each of the voltage regulator 120P and the capacitors C21P, C22P, C23P, and C24P includes or is made from one or more PMOS transistor. The voltage regulator 120P and the capacitors C21P, C22P, C23P, and C24P form a PMOS area of the semiconductor system 600. The voltage regulator 120P is surrounded by the capacitors C21P, C22P, C23P, and C24P. Capacitors C21P and C22P are larger than capacitors C23P and C24P.

In addition, each of the voltage regulator 120N and the capacitors C21N, C22N, C23N, and C24N includes or is made from one or more NMOS transistor. The voltage regulator 120N and the capacitors C21N, C22N, C23N, and C24N form a NMOS area of the semiconductor system 600. The voltage regulator 120N is surrounded by the capacitors C21N, C22N, C23N, and C24N. Capacitors C21N and C22N are larger than capacitors C23N and C24N.

As shown from a top view of FIG. 6, the ports VDD, MID, and GND are formed on the same escalation level. The ports VDD, MID, and GND are disposed in a back end of line (BEOL). The voltage regulators 120P and 120N, and capacitors C21P, C22P, C23P, C24P, C21N, C22N, C23N, C24N are formed on the same escalation level. The voltage regulators 120P and 120N, and capacitors C21P, C22P, C23P, C24P, C21N, C22N, C23N, and C24N are disposed in a front end of line (FEOL). The ports VDD, MID, and GND are formed above the voltage regulators 120P and 120N, and capacitors C21P, C22P, C23P, C24P, C21N, C22N, C23N, C24N. The escalation level of the voltage regulators 120P and 120N and the capacitors C21P, C22P, C23P, C24P, C21N, C22N, C23N, C24N is below or lower than the escalation level of the ports VDD, MID, and GND.

In some embodiments, the port MID is formed between the port VDD and the port GND. Furthermore, the port VDD is formed above the PMOS area. The port GND is formed above the NMOS area. The port MID is formed above a portion of PMOS area and a portion of NMOS area. In addition, the port VDD overlaps the PMOS area from a top view. The port GND overlaps the NMOS area from a top view. The port MID overlaps a portion of PMOS area and a portion of NMOS area from a top view. As a result, the footprint of the semiconductor system 600 can be decreased.

Some embodiments of the present disclosure provide a semiconductor system including a voltage regulator, a first capacitor and a second capacitor. The voltage regulator is configured to modulate a sinking current and a sourcing current associated with a plurality of loading circuits. Each of the plurality of loading circuits may include a high-voltage portion and a low-voltage portion. The first capacitor is electrically connected to the voltage regulator to stabilize the sinking current from each of the high-voltage portion of the plurality of loading circuits. The first capacitor is external to the plurality of loading circuits. The second capacitor, electrically connected to the voltage regulator to stabilize the sourcing current transmitted to each of the low-voltage portion of the plurality of loading circuits. The second capacitor is external to the plurality of loading circuits.

Some embodiments of the present disclosure provide a semiconductor system including a voltage regulator, a first capacitor and a second capacitor. The voltage regulator is configured to regulate an output voltage for a plurality of loading circuits. The voltage regulator includes an amplifier and a biasing circuit.

The amplifier is configured to provide a sinking current and a sourcing current to the plurality of loading circuits. The biasing circuit is configured to dynamically control the amplifier in response to a comparison between the output voltage and a reference voltage. The amplifier is configured to provide the sinking current when the output voltage is greater than the reference voltage, and the amplifier is configured to provide the sourcing current when the output voltage is lower than the reference voltage. The first capacitor is electrically connected to the voltage regulator to stabilize the sinking current from the loading circuits. The second capacitor is electrically connected to the voltage regulator to stabilize the sourcing current to the loading circuits.

Some embodiments of the present disclosure provide a method for operating a semiconductor system. The method includes controlling, by a voltage regulator, a sinking current and a sourcing current associated with a plurality of loading circuits; stabilizing, by a first capacitor, the sinking current transmitted from a high-voltage portion of the loading circuits, where the first capacitor is external to the loading circuits; stabilizing, by a second capacitor, the sourcing current transmitted to a low-voltage portion of the load circuits, where the second capacitor is external to the loading circuits; decreasing noise of the high-voltage portion by a third capacitor embedded within the loading circuits; and decreasing noise of the low-voltage portion by a fourth capacitor embedded within the loading circuits.

The foregoing outlines structures of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A semiconductor system, comprising:
a voltage regulator, configured to modulate a sinking current and a sourcing current associated with a plurality of loading circuits, wherein each of the plurality of loading circuits comprises a high-voltage portion and a low-voltage portion;
a first capacitor, electrically connected to the voltage regulator to stabilize the sinking current from each of the high-voltage portion of the plurality of loading circuits, wherein the first capacitor is external to the plurality of loading circuits; and
a second capacitor, electrically connected to the voltage regulator to stabilize the sourcing current transmitted to each of the low-voltage portion of the plurality of loading circuits, wherein the second capacitor is external to the plurality of loading circuits.

2. The semiconductor system of claim 1, wherein each of the plurality of the loading circuits comprising:
a third capacitor, electrically connected to a first port and adjacent to the high-voltage portion, configured to decrease noise of the high-voltage portion; and
a fourth capacitor, electrically connected to a second port and adjacent to the low-voltage portion, configured to decrease noise of the low-voltage portion.

3. The semiconductor system of claim 2, wherein when the high-voltage portion is operated, the sinking current passes from the high-voltage portion through the first port to the voltage regulator.

4. The semiconductor system of claim 3, wherein when the low-voltage portion is operated, the sourcing current passes from the voltage regulator through the second port to the low-voltage portion.

5. The semiconductor system of claim 2, wherein the plurality of loading circuits are formed above the voltage regulator.

6. The semiconductor system of claim 5, wherein the loading circuits comprise a plurality of metal layers, a first portion of the metal layers are configured for routing signals of the plurality of loading circuits, and a second portion (Mn+1˜Mx) of the metal layers above the first portion in a cross-sectional perspective are configured to form the third capacitor and the fourth capacitor.

7. The semiconductor system of claim 6, further comprising:
a voltage supply port, electrically connected to the first capacitor, the third capacitor and the high-voltage portion; and
a ground port, electrically connected to the second capacitor, the fourth capacitor and the low-voltage portion.

8. The semiconductor system of claim 7, wherein the voltage supply port, the ground port, the first port and the second port are formed above the second portion of the metal layers in a cross-sectional perspective.

9. The semiconductor system of claim 8, wherein in a top view perspective, the first port and the second port are formed between the voltage supply port and the ground port, the voltage supply port is formed above a PMOS area of the voltage regulator, and the ground port is formed above a NMOS area of the voltage regulator.

10. A semiconductor system, comprising:
a voltage regulator, configured to regulate an output voltage for a plurality of loading circuits, comprising:
an amplifier, configured to provide a sinking current and a sourcing current to the plurality of loading circuits; and
a biasing circuit, configured to dynamically control the amplifier in response to a comparison between the output voltage and a reference voltage, wherein the amplifier is configured to provide the sinking current when the output voltage is greater than the reference voltage, and the amplifier is configured to provide the sourcing current when the output voltage is lower than the reference voltage;
a first capacitor, electrically connected to the voltage regulator to stabilize the sinking current from the loading circuits; and
a second capacitor, electrically connected to the voltage regulator to stabilize the sourcing current to the loading circuits.

11. The semiconductor system of claim 10, wherein the amplifier comprises a first PMOS transistor and a first NMOS transistor, the biasing circuit is electrically connected to gate of the first PMOS transistor through a first node and to gate of the first NMOS transistor through a second node, and the voltage regulator further comprises a differential pair circuit.

12. The semiconductor system of claim 11, wherein the differential pair circuit comprises:
a second PMOS transistor, wherein gate of the second PMOS transistor is configured to receive the reference voltage;
a third PMOS transistor, wherein gate of the third PMOS transistor is configured to receive the output voltage; and
a second NMOS transistor, electrically connected to the second PMOS transistor.

13. The semiconductor system of claim 12, wherein when the output voltage is greater than the reference voltage, voltage at the first node is increased to decrease the output voltage.

14. The semiconductor system of claim 13, wherein when voltage at gate of the second NMOS transistor increases, voltages at the first node and the second node are configured to increase in response, such that the output voltage approximates the reference voltage.

15. The semiconductor system of claim 12, wherein when the output voltage is lower than the reference voltage, voltage at the first node is decreased to increase the output voltage.

16. The semiconductor system of claim 15, wherein when voltage at gate of the second NMOS transistor decreases, voltages at the first node and the second node are configured to decrease in response, such that the output voltage approximates the reference voltage.

17. The semiconductor system of claim 11, wherein when the loading circuits is operated in a high-voltage range, the sinking current passes from the loading circuits to the first NMOS transistor of the voltage regulator.

18. The semiconductor system of claim 11, wherein when the loading circuits is operated in a low-voltage range, the sourcing current passes from the first PMOS transistor of the voltage regulator to the loading circuits.

19. A method for operating a semiconductor system, comprising:
controlling, by a voltage regulator, a sinking current and a sourcing current associated with a plurality of loading circuits;
stabilizing, by a first capacitor, the sinking current transmitted from a high-voltage portion of the loading circuits, wherein the first capacitor is external to the loading circuits;
stabilizing, by a second capacitor, the sourcing current transmitted to a low-voltage portion of the load circuits, wherein the second capacitor is external to the loading circuits;
decreasing noise of the high-voltage portion by a third capacitor embedded within the loading circuits; and
decreasing noise of the low-voltage portion by a fourth capacitor embedded within the loading circuits.

20. The method of claim 19, further comprising:
providing the sinking current and the sourcing current to the loading circuits by an amplifier; and
dynamically controlling the amplifier, by a biasing circuit, in response to a comparison between an output voltage and a reference voltage.
